(19) United States
(12) Patent Application Publication
(10) Pub. No.: US 2018/0363544 A1
(43) Pub. Date: Dec. 20, 2018

(54) SHAFT DRIVEN ENGINE ACCESSORIES

(71) Applicant: Schaeffler Technologies AG & Co. KG, Herzogenaurach (DE)

(72) Inventors: Ralph Zanzig, Hohen Neuendorf (DE); Jeffrey Hemphill, Copley, OH (US); Kevin Parks, Wooster, OH (US); Chris Luipold, Wadsworth, OH (US); Philip George, Wooster, OH (US)

(73) Assignee: Schaeffler Technologies AG & Co. KG, Herzogenaurach (DE)

(21) Appl. No.: 15/515,514

(22) PCT Filed: Sep. 29, 2015
(86) PCT No.: PCT/US15/02896

§ 371 Date: Mar. 29, 2017

Related U.S. Application Data
(60) Provisional application No. 62/056,815, filed on Sep. 29, 2014.

(51) Int. Cl. F02B 67/06; F16D 1/10; F16D 1/033; F16H 7/02; F16H 57/00

(52) U.S. Cl. CPC F02B 67/06; F16D 1/10; F16D 2001/103; F16H 7/02; F16H 57/0025; F16D 1/033

(57) ABSTRACT

An engine accessory assembly includes a common shaft and at least two axially aligned engine accessories drivingly connected to the common shaft. The at least two axially aligned engine accessories may be an alternator, a motor generator unit, a vacuum pump, a transmission oil pump, an engine oil pump or a water pump. In an example embodiment, the common shaft includes a spline and the at least two axially aligned engine accessories are drivingly engaged with the spline.

### CROSS-REFERENCE TO RELATED APPLICATIONS

This application claims the benefit under 35 U.S.C. § 119(e) of U.S. Provisional Patent Application No. 62/056,815 filed Sep. 29, 2014, hereby incorporated by reference as if set forth fully herein.

### FIELD

The invention relates generally to an accessory drive for a transmission, and more specifically to an accessory drive using a common shaft.

### BACKGROUND

Engine accessory drives are known. Examples are shown in U.S. Pat. Nos. 5,700,212 and 6,609,491 and United States Patent Application Publication No. 2009/0255741.

### BRIEF SUMMARY

Example aspects broadly comprise an engine accessory assembly including a common shaft and at least two axially aligned engine accessories drivingly connected to the common shaft The at least two axially aligned engine accessories may be an alternator, a motor generator unit, a vacuum pump, a transmission oil pump, an engine oil pump or a water pump. In an example embodiment, the common shaft includes a spline and the at least two axially aligned engine accessories are drivingly engaged with the spline. In some example embodiments, one of the at least two axially aligned engine accessories is the motor generator unit, the motor generator unit includes a first bearing, and the common shaft is fixed to an output shaft of the motor generator unit and supported by the bearing. In an example embodiment, the engine accessory assembly includes a second bearing. The first bearing supports a first distal end of the shaft and the second bearing supports a second distal end of the shaft, opposite the first distal end.

In some example embodiments, one of the at least two axially aligned engine accessories is the engine oil pump and the engine oil pump includes a mounting bracket for fixing the engine accessory assembly to an engine. In an example embodiment, the engine oil pump includes an engine oil filter. In an example embodiment, the engine accessory assembly includes a hose. One of the at least two axially aligned engine accessories is the water pump with an outlet, another of the at least two axially aligned engine accessories is the motor generator unit with a cooling inlet and the hose connects the water pump outlet with the motor generator unit cooling inlet.

In some example embodiments, one of the at least two axially aligned engine accessories includes a polygonal protrusion, another of the at least two axially aligned engine accessories includes a polygonal recess, complementary to the polygonal protrusion, and the polygonal protrusion is installed in the polygonal recess. In some example embodiments, one of the at least two axially aligned engine accessories is the vacuum pump, another of the two at least axially aligned engine accessories is the transmission pump, and a polygonal protrusion on the vacuum pump is the same as a polygonal protrusion on the transmission pump. In an example embodiment, the polygonal protrusion is a triangle, a square, a pentagon, a hexagon, or an octogon. In an example embodiment, the one of the at least two axially aligned engine accessories and the another of the at least two axially aligned engine accessories are joined together with fasteners.

In an example embodiment, the common shaft is connectable to an engine crankshaft and/or a transmission input shaft. In an example embodiment, the engine accessory assembly includes a radially offset air conditioner compressor and a belt drivingly connecting the common shaft to the axially offset air conditioner compressor. In an example embodiment, the engine accessory assembly includes at least three axially aligned engine accessories.

### BRIEF DESCRIPTION OF THE DRAWINGS

The nature and mode of operation of the present invention will now be more fully described in the following detailed description taken with the accompanying drawing figures, in which:

FIG. 1 is a perspective view of a combustion engine and transmission showing an engine accessory assembly according to an example aspect;

FIG. 2 is a side view of the engine accessory assembly of FIG. 1;

FIG. 3 is an exploded perspective view of the engine accessory assembly of FIG. 2;

FIG. 4 is an exploded perspective view of the engine accessory assembly of FIG. 2;

FIG. 5 is an exploded detail perspective view of a motor generator unit to shaft connection according to an example aspect;

FIG. 6 is an exploded detail perspective view of the motor generator unit to shaft connection of FIG. 5;

FIG. 7 is an exploded detail perspective view of an accessory-to-accessory connection according to an example aspect;

FIG. 8 is an exploded detail perspective view of the accessory-to-accessory connection of FIG. 7;

FIG. 9 is an exploded detail perspective view of an accessory-to-accessory connection according to an example aspect;

FIG. 10 is an exploded detail perspective view of the accessory-to-accessory of FIG. 9;

FIG. 11 is a detail perspective view of the engine accessory assembly of FIG. 2.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

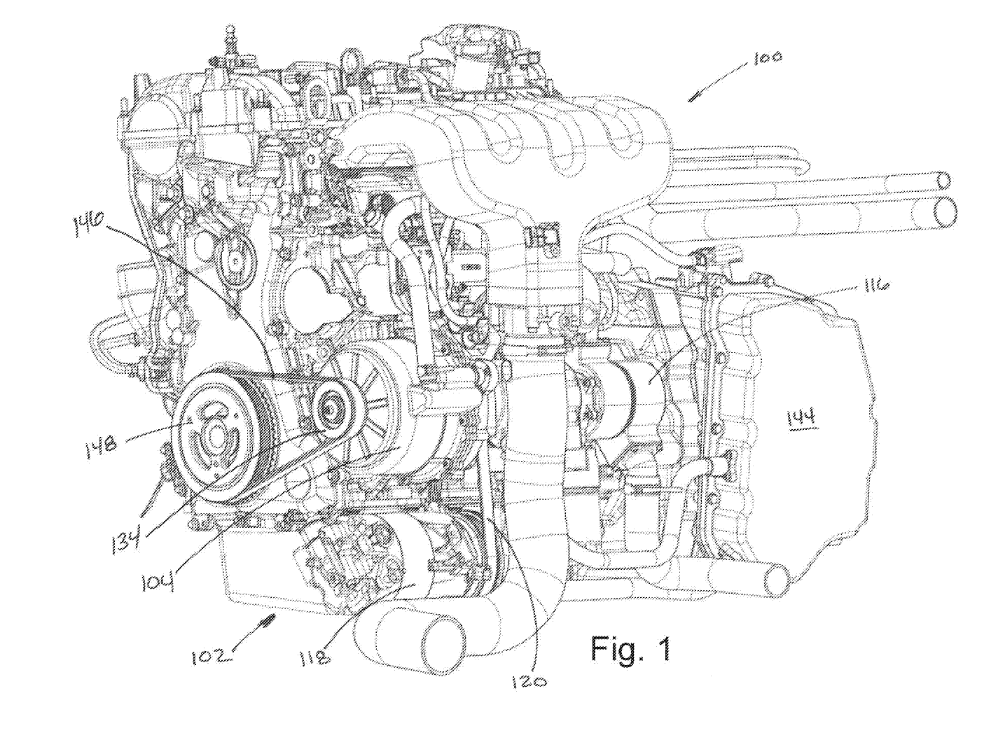

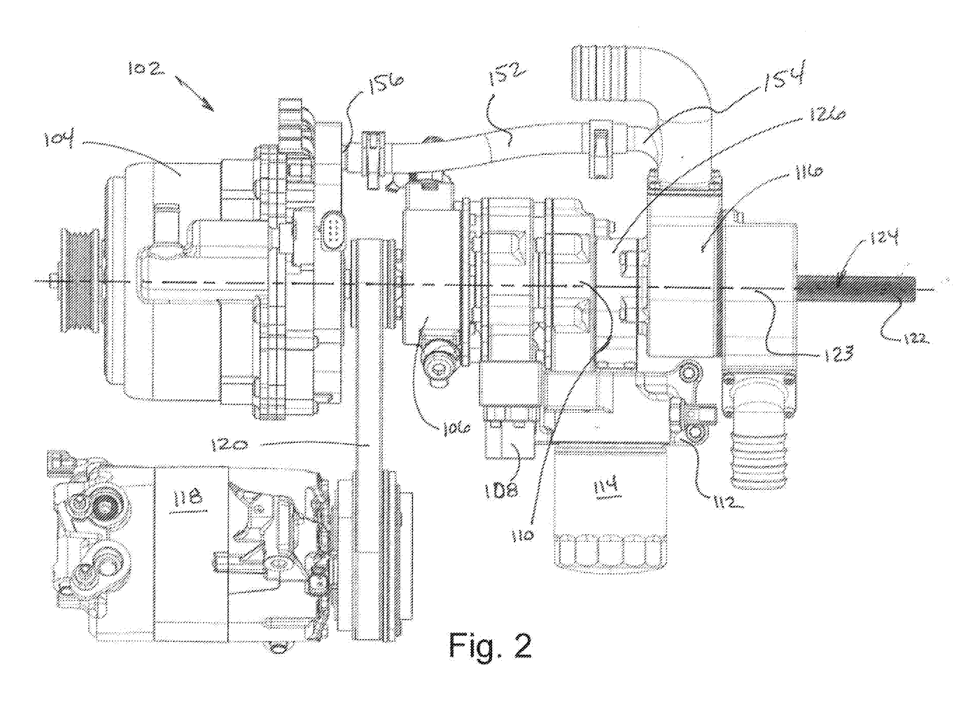

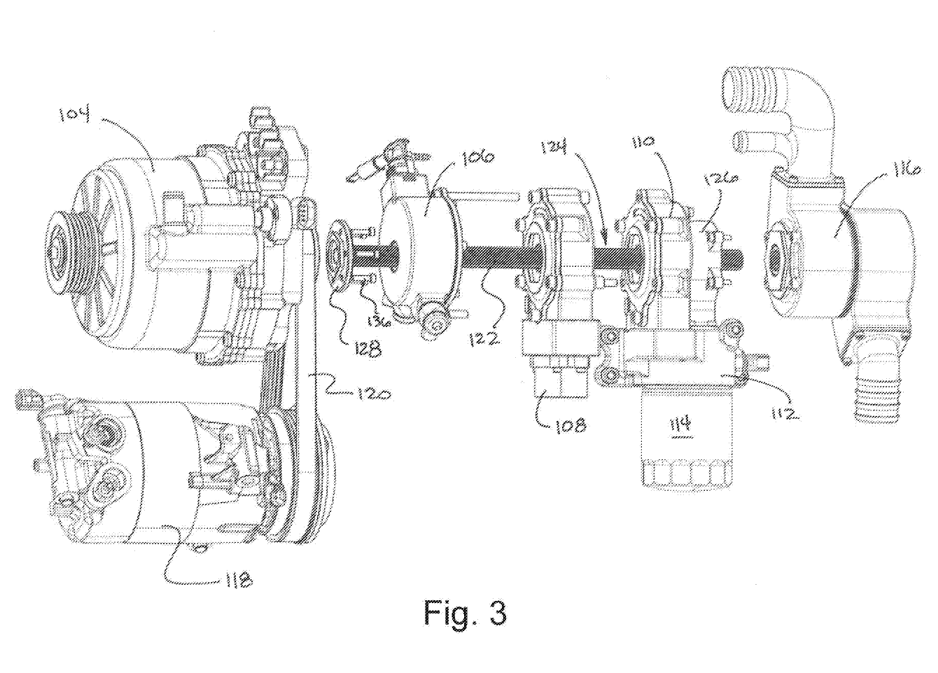

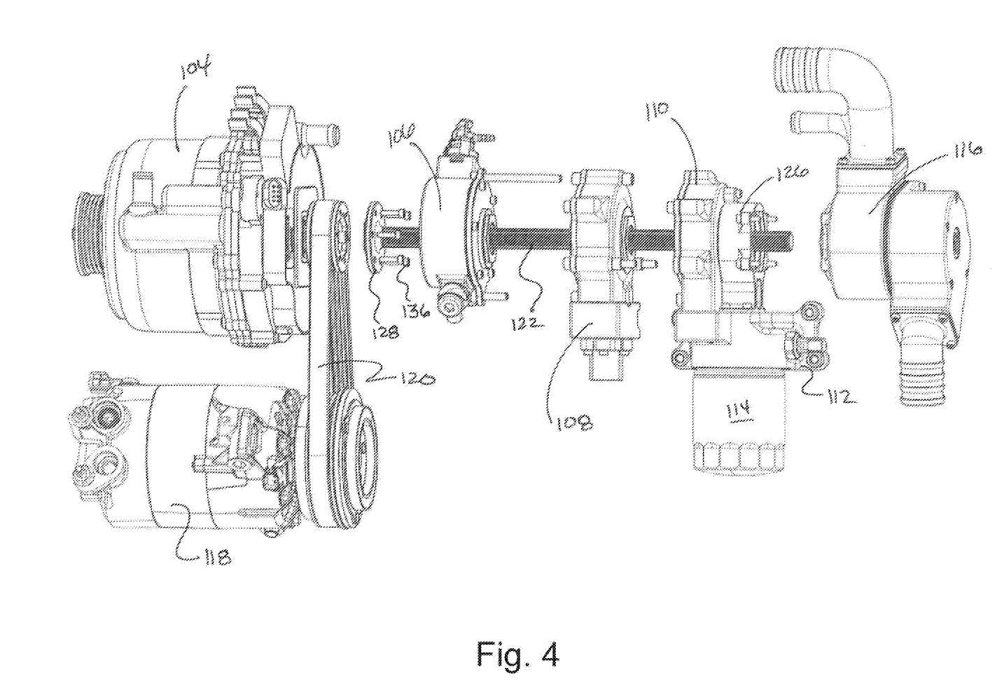

The following description is made with reference to FIGS. 1-4. FIG. 1 is a perspective view of a combustion engine and transmission showing an engine accessory assembly according to an example aspect. FIG. 2 is a side view of the engine accessory assembly of FIG. 1. FIG. 3 is an exploded perspective view of the engine accessory assembly of FIG. 2. FIG. 4 is an exploded perspective view of the engine accessory assembly of FIG. 2.

The figures show engine 100 with engine accessory assembly 102 including motor generator unit 104, vacuum pump 106, transmission oil pump 108, engine oil pump 110 including bracket 112 and filter 114, and water pump 116. Also shown is off-axis air conditioning compressor 118 connected by belt 120. In some example embodiments (not shown), motor generator unit 104 is an alternator. The shaft driven accessories are drivingly connected by shaft 122. Shaft 122 includes splines 124 for drivingly engaging the engine accessories as described below. Shaft 122 is supported by a bearing in motor generator unit 104 and a bearing disposed in housing 126 fixed to engine oil pump 110. As can be seen from the figures, the bearings are disposed at opposite distal ends of shaft 122.

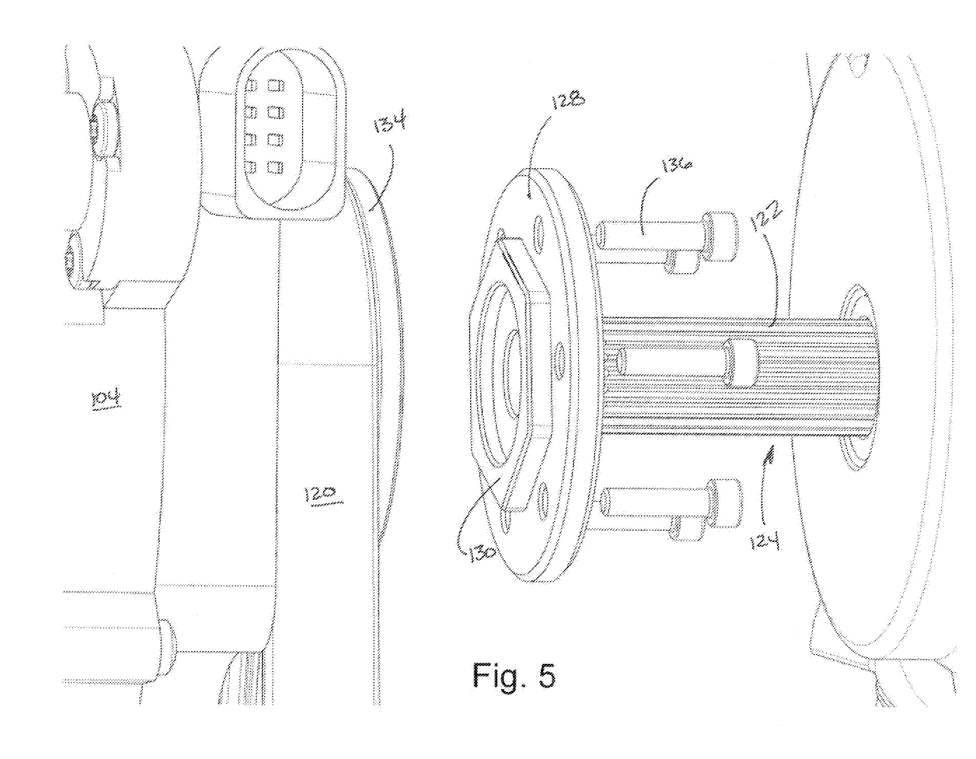

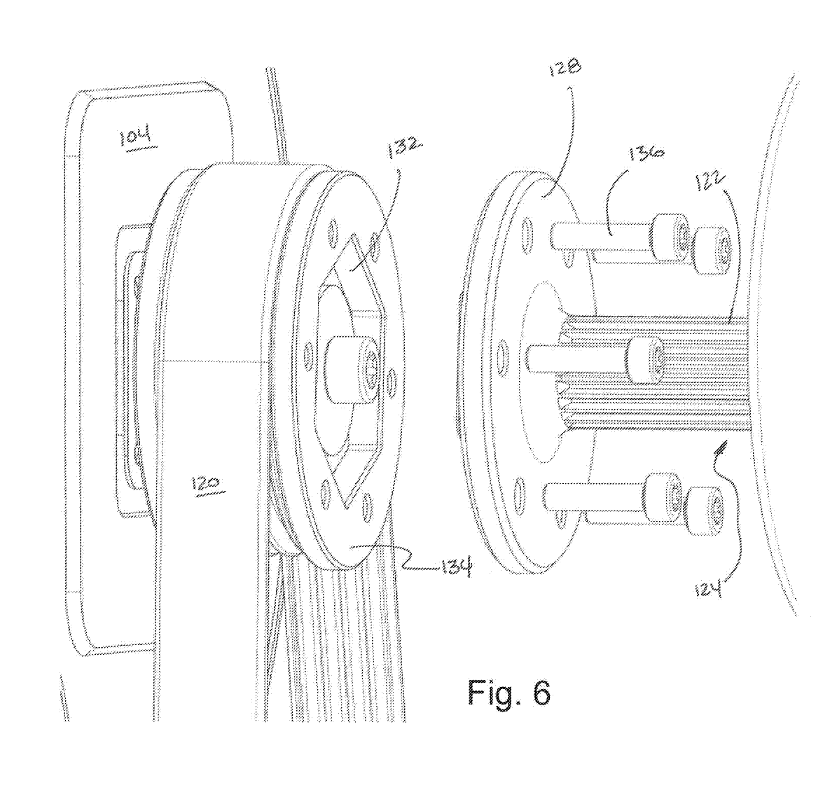

The following description is made with reference to FIGS. 5 and 6. FIG. 5 is an exploded detail perspective view of a motor generator unit to shaft connection according to an example aspect. FIG. 6 is an exploded detail perspective view of the motor generator unit to shaft connection of FIG. 5. Shaft 122 includes drive connection flange 128 with hexagonal protrusion 130 for driving connection with recess 132 in motor generator pulley 134. Bolts 136 secure the flange to the motor generator pulley and the hexagonal drive rotationally connects the components. In the example embodiment shown in FIGS. 5 and 6, protrusion 130 and recess 132 are hexagonal, but other polygonal shapes are possible, including but not limited to, triangular, rectangular, pentagonal, or octagonal. Similarly, although the protrusion is shown in flange 128 and the recess in pulley 134, an opposite configuration with a protrusion in the pulley and a recess in the flange is also possible.

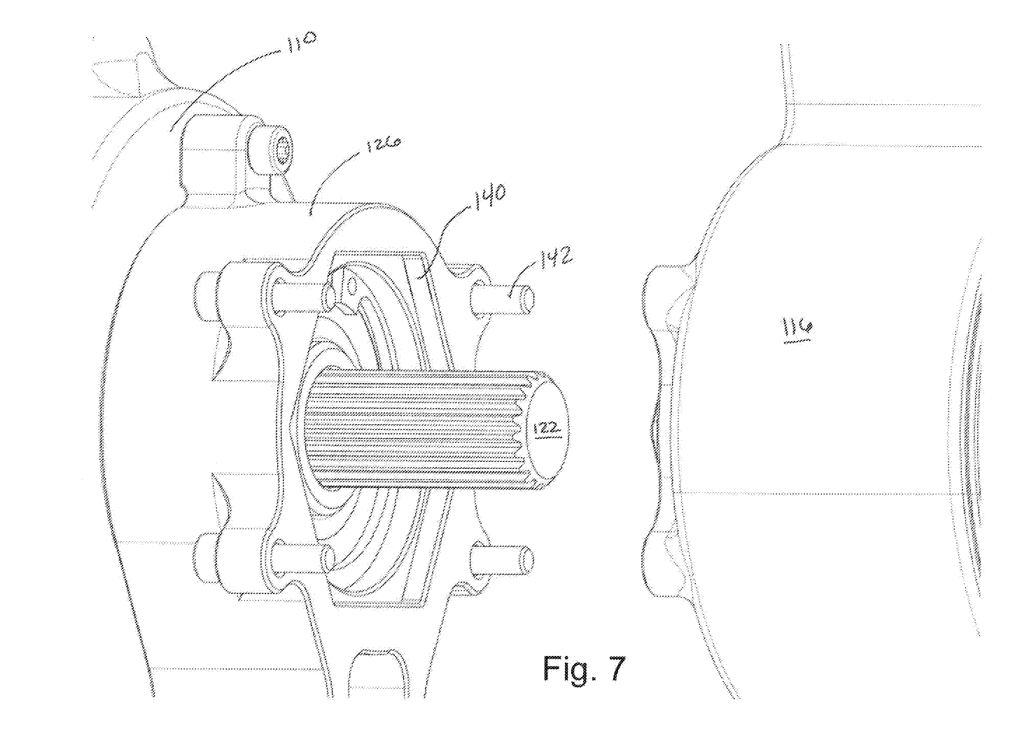

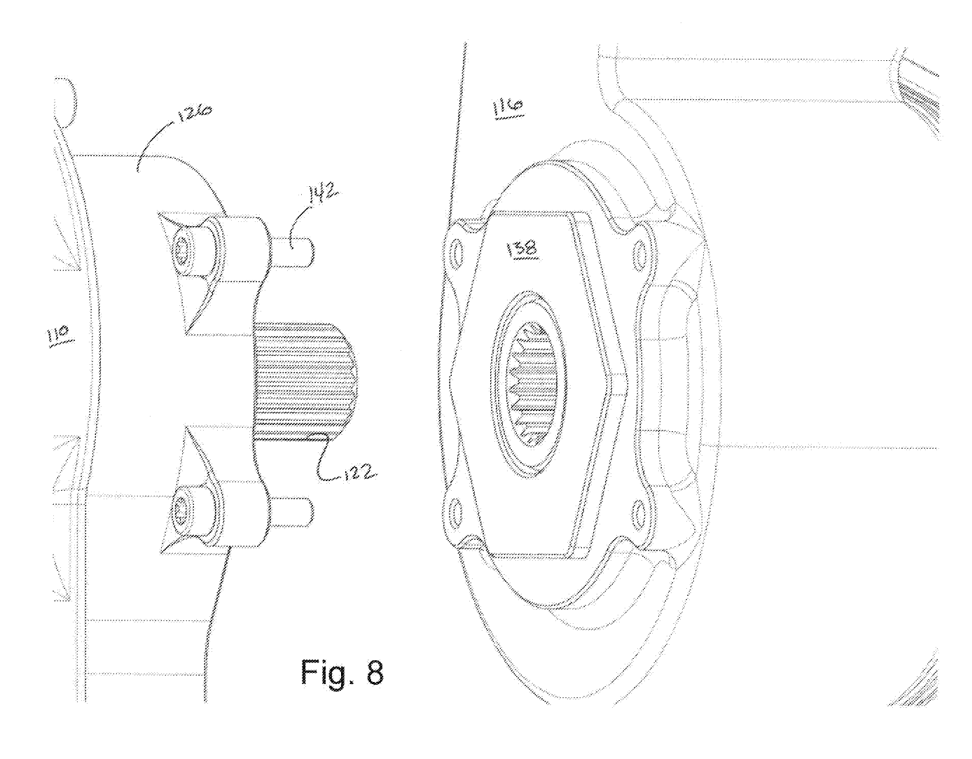

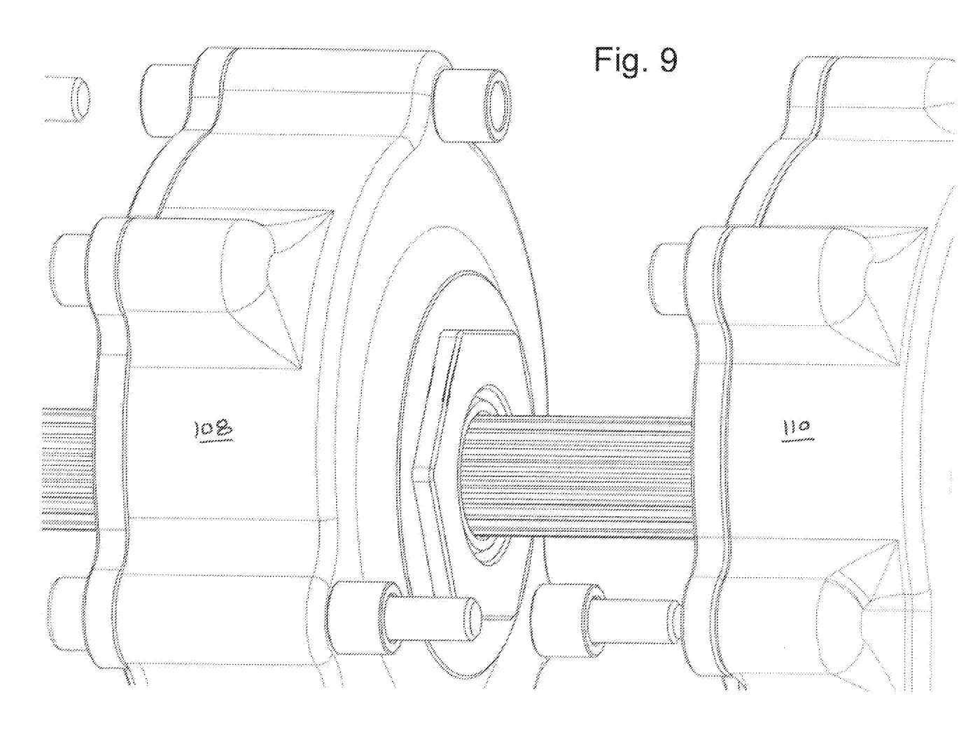

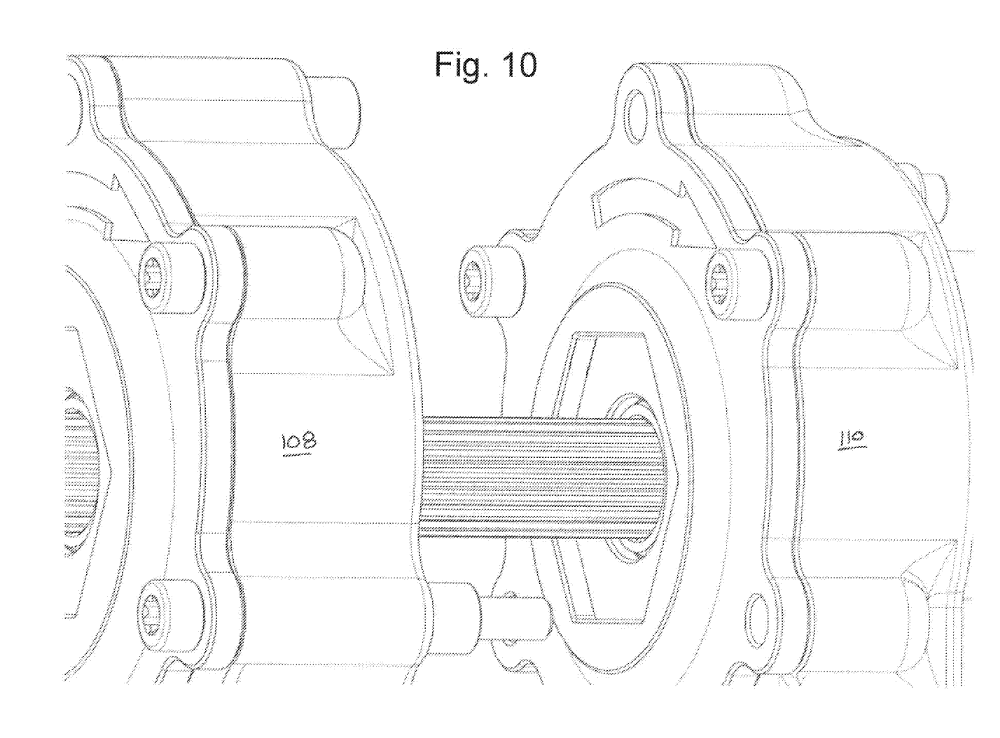

The following description is made with reference to FIGS. 7-10. FIG. 7 is an exploded detail perspective view of an accessory-to-accessory connection according to an example aspect. FIG. 8 is an exploded detail perspective view of the accessory-to-accessory connection of FIG. 7. FIG. 9 is an exploded detail perspective view of an accessory-to-accessory connection according to an example aspect. FIG. 10 is an exploded detail perspective view of the accessory-to-accessory of FIG. 9. Each of the accessories is connected to the assembly using a polygonal fit and fasteners. That is, water pump 116 includes hexagonal protrusion 138 and vacuum pump 106 includes hexagonal recess 140 so that, when the mating accessories are assembled, they are rotationally fixed. In the example embodiment shown in FIGS. 8-10, the polygonal fit is a hexagon although other fits including triangle, square, pentagon, or octogon are possible. Fasteners 142 may be screws or bolts.

Transmission oil pump 108 and vacuum pump 106 include a same connection so that either may be installed onto engine oil pump 110, depending on application. That is, for applications not requiring a transmission oil pump (i.e., manual transmission or dry double clutch transmission), the vacuum pump can be fixed directly to the oil pump. Similarly, some applications (i.e., non-turbocharged) may not require a vacuum pump. In this manner, the engine accessory assembly is adaptable to a variety of engine and transmission applications.

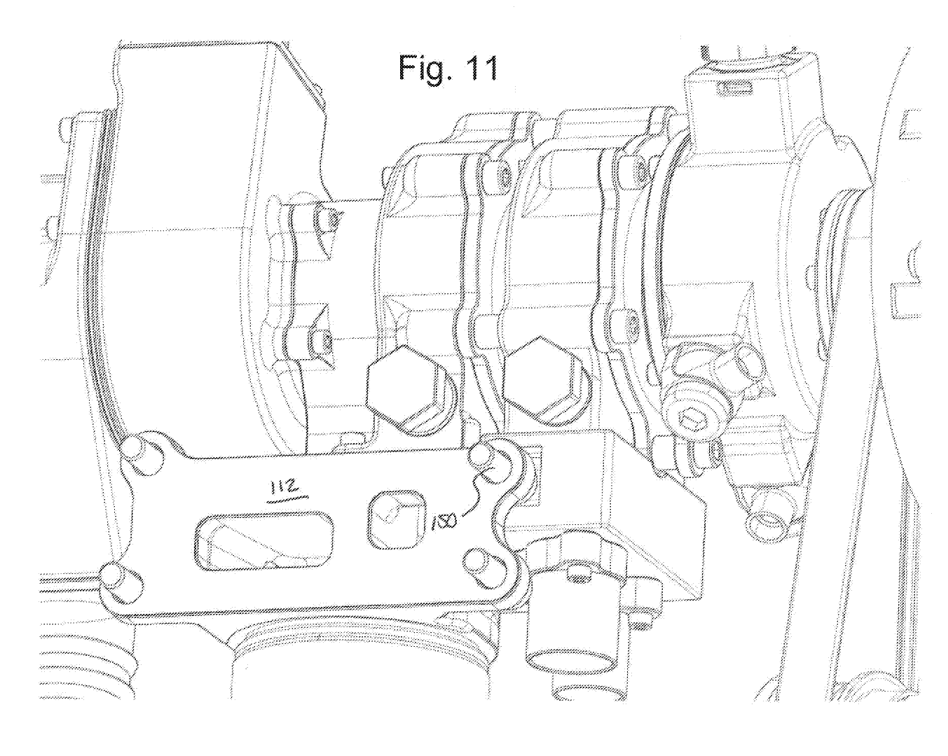

The following description is made with reference to FIGS. 1-2 and 11. FIG. 11 is a detail perspective view of the accessory drive of FIG. 2. Radially offset air conditioner compressor 118 is connected by belt 120 to motor generator unit pulley 134 mounted on a shaft of motor generator unit 104. Engine accessory assembly 102 is fixed to engine 100 via motor generator unit 104 and engine oil pump bracket 112. The spline shaft is drivingly connected to engine 100 and transmission 144 via a clutch mechanism (not shown) selectable to drive the shaft from the engine or transmission as shown and described in commonly-assigned United States Patent Application Publication No. 2014/0290406, herby incorporated by reference as if set forth fully herein. Other applications in which the accessories are driven by the engine only may include stretch belt 146 connecting crankshaft pulley 148 to motor generator unit pulley 134. In these applications, spline shaft 122 is shorter and does not connect to the transmission.

The following description is made with reference to FIGS. 1-11. Engine accessory assembly 102 includes common shaft 122 and axially aligned engine accessories 106, 108, 110, and 116 drivingly connected to the common shaft. That is, shaft 122 includes axis 123 and each of the axially aligned engine accessories include respective axes aligned with shaft axis 123. In the example embodiment shown, the axially aligned engine accessories are motor generator unit 104, vacuum pump 106, transmission oil pump 108, engine oil pump 110 and water pump 116. Other embodiments may include an alternator (not shown) in place of the motor generator.

Common shaft 122 includes spline 124 and at least some of the engine accessories are drivingly engaged with the spline (ref. FIGS. 7-10). Motor generator unit 104 includes a first bearing (not shown), and common shaft 122 is fixed to an output shaft of the motor generator unit and supported by the bearing as described above. Engine accessory assembly 102 includes a second bearing (not shown) disposed within housing 126. The first bearing supports a first distal end of the shaft and the second bearing supports a second distal end of the shaft, opposite the first distal end.

Engine oil pump 110 includes mounting bracket 112 (ref. FIG. 11) for fixing the engine accessory assembly to engine 100. Engine oil pump 110 includes engine oil filter 114. Bolts 150 connect the bracket to the engine. Hose 152 connects water pump outlet 154 to motor generator cooling inlet 156, providing engine coolant flow to the motor generator to prevent overheating.

As described above, the individual accessories are connected together by way of mating polygonal features. That is, one of the axially aligned engine accessories includes a polygonal protrusion and another of the axially aligned engine accessories includes a polygonal recess, complementary to the polygonal protrusion, and the polygonal protrusion is installed in the polygonal recess. In addition, the vacuum pump and the transmission oil pump can share the same polygonal protrusion facilitating various accessory configurations, as described above in more detail. The polygonal protrusion can be a triangle, a square, a pentagon, a hexagon, or an octagon, for example. Each of the axially aligned engine accessories are joined together with fasteners.

As described above, the common shaft may be connectable to an engine crankshaft and/or a transmission input shaft. In the embodiment shown, the engine accessory assembly includes a radially offset air conditioner compressor and a belt drivingly connecting the common shaft to the axially offset air conditioner compressor. In the embodiment shown, the engine accessory assembly includes five axially aligned engine accessories, namely motor generator 104, vacuum pump 106, transmission oil pump 108, engine oil pump 110, and water pump 116.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. An engine accessory assembly comprising:
a common shaft; and,
at least two axially aligned engine accessories selected from the group of:
an alternator;
a motor generator unit;
a vacuum pump;
a transmission oil pump;
an engine oil pump; and,
a water pump;
drivingly connected with a common shaft.

2. The engine accessory assembly wherein the common shaft includes a spline and at least one of the at least two axially aligned engine accessories is drivingly engaged with the spline.

3. The engine accessory assembly of claim 1 wherein:
one of the at least two axially aligned engine accessories is the engine oil pump; and,
the engine oil pump includes a mounting bracket for fixing the engine accessory assembly to an engine.

4. The engine accessory assembly of claim 1 further comprising a hose wherein:
one of the at least two axially aligned engine accessories is the water pump with an outlet;
another of the at least two axially aligned engine accessories is the motor generator unit with a cooling inlet; and,
the hose connects the water pump outlet with the motor generator unit cooling inlet.

5. The engine accessory assembly of claim 1 wherein:
one of the at least two axially aligned engine accessories includes a polygonal protrusion;
another of the at least two axially aligned engine accessories includes a polygonal recess, complementary to the polygonal protrusion; and,
the polygonal protrusion is installed in the polygonal recess.

6. The engine accessory assembly of claim 5 wherein:
one of the at least two axially aligned engine accessories is the vacuum pump;
another of the two at least axially aligned engine accessories is the transmission pump; and,
a polygonal protrusion on the vacuum pump is the same as a polygonal protrusion on the transmission pump.

7. The engine accessory assembly of claim 5 where the polygonal protrusion is selected from the group of:
a triangle;
a square;
a pentagon;
a hexagon; and
an octogon.

8. The engine accessory assembly of claim 5 wherein the one of the at least two axially aligned engine accessories and the another of the at least two axially aligned engine accessories are joined together with fasteners.

9. The engine accessory assembly of claim 1 wherein the common shaft is connectable to an engine crankshaft and/or a transmission input shaft.

10. The engine accessory assembly of claim 1 further comprising:
a radially offset air conditioner compressor; and,
a belt drivingly connecting the common shaft to the axially offset air conditioner compressor.
